(19) United States
(12) Patent Application Publication
(10) Pub. No.: US 2026/0169921 A1
(43) Pub. Date: Jun. 18, 2026

(54) DEVICE, METHOD AND SYSTEM FOR ENABLING A REGION-SPECIFIC PREFETCH FILTER

(71) Applicant: Intel Corporation, Santa Clara, CA (US)

(72) Inventor: Gino Chacon, Beaverton, OR (US)

(73) Assignee: Intel Corporation, Santa Clara, CA (US)

(21) Appl. No.: 18/986,320

(22) Filed: Dec. 18, 2024

(51) Int. Cl. G06F 12/0862; G06F 9/32; G06F 12/0882

(52) U.S. Cl. CPC G06F 12/0862; G06F 9/321; G06F 12/0882

(57) ABSTRACT

Techniques and mechanisms for determining an enablement state of a prefetch functionality based on a history of accesses to a memory region. In an embodiment, an access history record, which corresponds to a page of a cache or other memory, is accessed to determine whether a detected address, in a demand memory access, is numerically adjacent to any of multiple most recently accessed addresses of the page. A metric of a confidence in adjacent-line prefetches for the page is updated based on a numerical adjacency of accessed addresses. The metric is evaluated to determine whether adjacent-line prefetches for the page are to be enabled or disabled. In another embodiment, the enabling or disabling of a prefetches for a given page is determined based on a determination as to whether or not said page was subject to a prefetch access and, subsequently, to a corresponding demand memory access.

### BACKGROUND

### 1. Technical Field

This disclosure generally relates to processor operations and more particularly, but not exclusively, to a selective and granular application of prefetch filters.

### 2. Background Art

Multiprocessor systems are becoming more and more common. Applications of multiprocessor systems include dynamic domain partitioning all the way down to desktop computing. In order to take advantage of some multiprocessor systems, code of a thread to be executed is separated by schedulers to various processing entities for out-of-order execution. Out-of-order execution executes instructions as input to such instructions is made available. Thus, an instruction that appears later in a code sequence is subject to being executed before an instruction appearing earlier in the code sequence.

Some modern computer processors include functionality to speculatively prefetch data during execution. For example, such a processor facilitates execution of a software program by prefetching data to be processed by the program, such as text or video information. The processor prefetches such data in an attempt to reduce the overall execution time of the software program.

As successive generations of processors continue to increase in number, variety, and capability, there is expected to be an increasing premium placed on improvements to efficient provisioning of data in support of program execution.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a system to enable a region-specific prefetch filter according to an embodiment.

FIG. 2 shows a flow diagram illustrating features of a method to selectively enable an adjacent-line prefetch filter according to an embodiment.

FIG. 3 shows a block diagram illustrating features of a processor to determine an enablement state of an adjacent-line prefetch filter according to an embodiment.

FIG. 4 shows a flow diagram illustrating features of a method to determine respective enablement states of region-specific adjacent-line prefetch filters according to an embodiment.

FIG. 5 shows a flow diagram illustrating features of a method to selectively enable a region-specific prefetch filter based on an access history according to an embodiment.

FIG. 6 shows a block diagram illustrating features of a processor to determine an enablement state of a region-specific prefetch filter based on an access history according to an embodiment.

FIG. 7 shows a flow diagram illustrating features of a method to determine enablement states of region-specific prefetch filters based on respective access histories according to an embodiment.

FIG. 8 illustrates an exemplary system.

FIG. 9 illustrates a block diagram of an example processor that may have more than one core and an integrated memory controller.

FIG. 10A is a block diagram illustrating both an exemplary in-order pipeline and an exemplary register renaming, out-of-order issue/execution pipeline according to examples.

FIG. 10B is a block diagram illustrating both an exemplary example of an in-order architecture core and an exemplary register renaming, out-of-order issue/execution architecture core to be included in a processor according to examples.

FIG. 11 illustrates examples of execution unit(s) circuitry.

FIG. 12 is a block diagram of a register architecture according to some examples.

### DETAILED DESCRIPTION

Embodiments discussed herein variously provide techniques and mechanisms for selectively applying prefetch filters which are each specific to a corresponding memory region and/or address space. The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Some embodiments variously facilitate the (re)configurability of one or more prefetch functionalities which, for example, each correspond to a different respective set of memory resources. For example, a configuration state of a prefetch filter comprises an enablement state of said filter, wherein the enablement state, at a given time, is one of an enabled state or a disabled state. In various embodiments, enabling a given prefetch filter comprises, or otherwise corresponds to, disabling or otherwise limiting a prefetch functionality which corresponds to said filter. Similarly, disabling said prefetch filter comprises, or otherwise corresponds to, enabling the corresponding prefetch functionality.

As used herein, “demand memory access” refers to a type of access to a given memory location which takes place as part of the execution of a program instruction which is explicitly to read (e.g., load) information from, or write (e.g., store) information to, said memory location. By contrast, “prefetch access” refers herein to another type of access to a given memory location which takes place in the absence of any program instruction which is explicitly to read information from, or write information to, said memory location.

As used herein, “address space” refers to a set of addresses which are to directly or indirectly identify respective memory locations each in a respective resource of one or more memory resources of a given device or system. A given portion (or “slice”) of such an address space comprises, for example, only a sub-set of all such addresses, wherein the respective addresses in a given slice are for memory locations each in the same one memory region (e.g., the same page of a cache or other memory).

In various embodiments, multiple slices of an address space each correspond to a different respective page or other suitable memory region. In some cases, a given slice comprises multiple addresses which, for example, are numerically contiguous with each other (although some embodiments are not limited in this regard). Additionally or alternatively, each location in a contiguous memory region corresponds to a respective address in the same slice (although some embodiments are not limited in this regard).

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a processor which supports prefetch filter functionality.

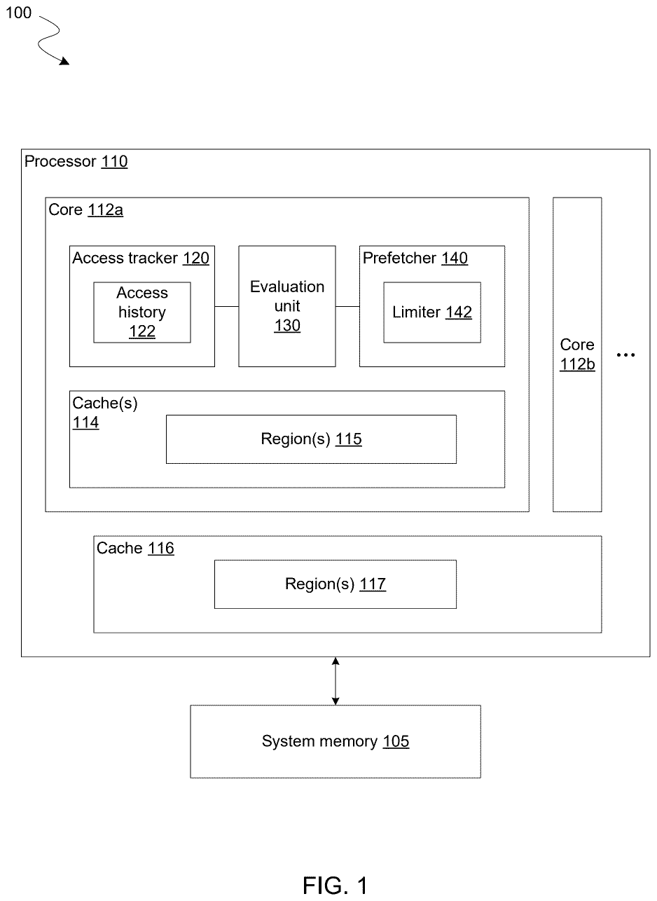

FIG. 1 shows a system 100 which enables a region-specific prefetch filter according to an embodiment. The system 100 illustrates features of one example embodiment wherein the application of a filter, to prefetches that are to access a particular portion of a memory resource, is selectively enabled or prevented based on a history of previous accesses to that memory resource portion.

In some embodiments, system 100 is all or a portion of an electronic device or component. For example, system 100 is (or otherwise comprises) a cellular telephone, a computer, a server, a network device, a system on a chip (SoC), a controller, a wireless transceiver, a power supply unit, or the like. Furthermore, in some embodiments, system 100 is any of various suitable groupings of related or interconnected devices, such as a datacenter, a computing cluster, etc.

As shown in FIG. 1, system 100 comprises a processor 110 and a system memory 105 which is operatively coupled thereto. Although not shown in FIG. 1, system 100 includes additional components, in some embodiments. In one or more embodiments, system memory 105 is implemented with any of various suitable type(s) of computer memory (e.g., dynamic random access memory (DRAM), static random-access memory (SRAM), non-volatile memory (NVM), a combination of DRAM and NVM, etc.).

Processor 110 is any of various suitable general purpose hardware processors (e.g., a central processing unit (CPU)) or special purpose hardware processors, for example. As shown, processor 110 includes any number of one or more processing cores 112 (e.g., including the illustrative cores 112a, 112b shown). A given one such core 112 facilitates functionality of a central processing unit, graphics processing unit, or the like—e.g., wherein said core 112 includes circuitry adapted from any of various conventional core architectures. For example, core 112a comprises any of a variety of suitable execution units (not shown)—e.g., including one or more arithmetic logic units (ALUs), one or more load pipelines, one or more store pipelines, and/or the like—circuitry of which is to perform algorithms for executing micro-operations and/or other such instructions, in accordance with the embodiment described herein.

In the example embodiment shown, processor 110 includes one or more caches to cache instructions and/or data. By way of illustration and not limitation, core 112a comprises one or more caches 114 which include, but are not limited to, some or all of a level one (L1) cache, and a level two (L2) cache. Alternatively or in addition, a cache 116 is shared by multiple ones of cores 112—e.g., wherein cache 116 is a last level cache (LLC) in a cache hierarchy of processor 110. Some embodiments are not limited to a particular number or configuration of the one or more caches of processor 110.

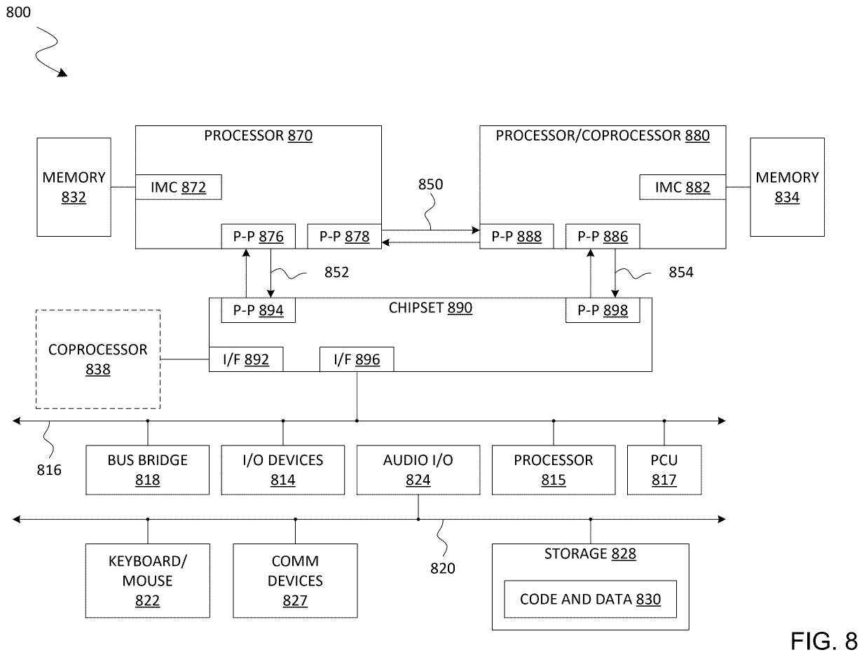

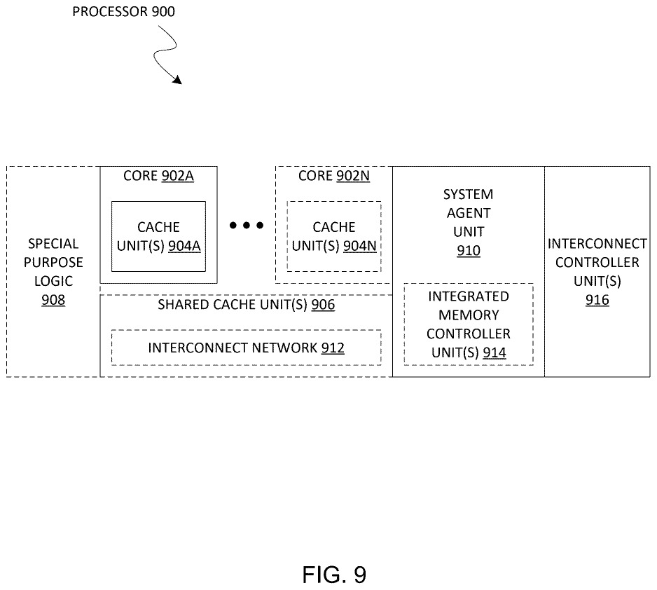

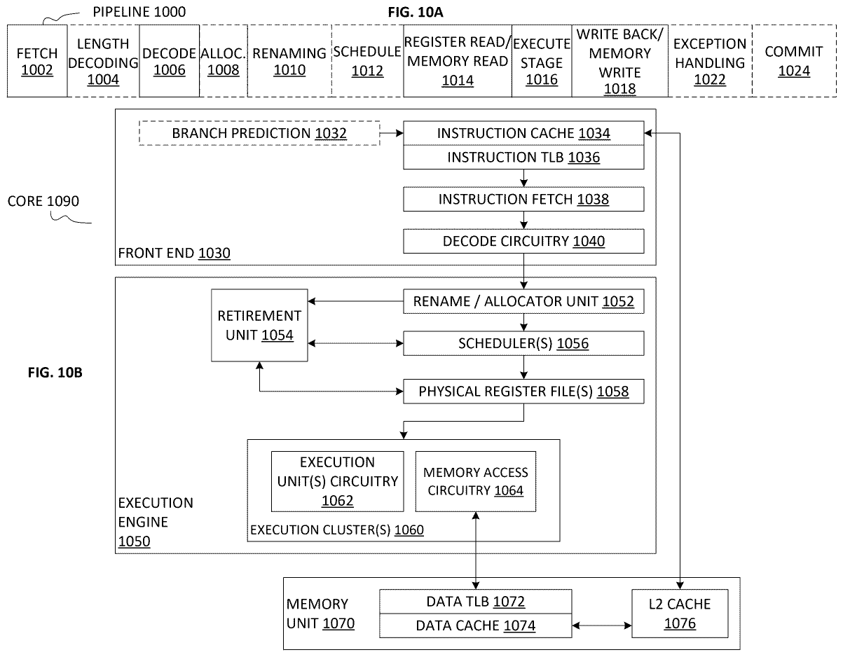

In some embodiments, circuitry of processor 110 is adapted from, and/or is incorporated with, any of various suitable processor architectures. By way of illustration and not limitation, any of various suitable embodiments of processor 110 are implemented, for example, in the processor 870 (FIG. 8), the processor/coprocessor 880 (FIG. 8), the processor 900 (FIG. 9), the pipeline 1000 (FIG. 10A), and/or the core 1090 (FIG. 10B).

In the example embodiment shown, processor 110 comprises a prefetcher 140 which, for example, is implemented with circuitry and/or micro-architecture of the core 112a. In another embodiment, some or all of prefetcher 140 is implemented with other circuitry of system 100—e.g., including uncore circuitry of processor 110. Note that, while FIG. 1 only shows prefetcher 140 as included in one core 112a, any or all cores 112 include the same or similar prefetch circuitry, in some embodiments.

In some embodiments, prefetcher 140 initiates, manages, and/or executes prefetch requests in the respective core 112a. For example, prefetcher 140 analyzes memory access requests to determine a data usage pattern in the core 112a. Prefetcher 140 uses the usage pattern to predict data that will be needed by the core 112a in a given time window. Prefetcher 140 then automatically generates a prefetch request for the predicted data. Further, in some embodiments, prefetcher 140 executes the prefetch request to read the predicted data from a repository (e.g., system memory 105, or a cache of processor 110), and stores the read data in a (different) cache of processor 110. In various embodiments, the generation of a prefetch request with prefetcher 140 includes operations that, for example, are adapted from conventional prefetch techniques (which are not detailed herein to avoid obscuring features of said embodiments).

To facilitate efficient prefetching according to some embodiments, prefetcher 140 includes, is coupled to access, or otherwise operates with, one or more limiter circuits (e.g., including the illustrative limiter 142 shown) each of which, when enabled, is to prevent or otherwise limit a respective prefetch functionality or a respective prefetch filter functionality.

In some embodiments, prefetch (re)configurability is provided—e.g., at a slice-specific (or, for example, a corresponding region-specific) level of granularity. By way of illustration and not limitation, prefetcher 140 is operable to selectively enable or disable a prefetch filter which only applies to one slice of an address space (and, for example, only a memory region which is addressable using addresses in said address space). In one such embodiment, prefetcher 140 is operable to selectively enable or disable any of multiple prefetch filters, independent of each other, where each such filter applies to prefetching for a different respective address slice (e.g., where each such filter applies to prefetching to or from a different respective memory region).

In various embodiments, one or more memory regions (e.g., pages) of system 100 each correspond to a different respective prefetch filter, wherein a given one such prefetch filter—when enabled—is to prevent or otherwise limit prefetching to and/or from the corresponding memory region. By way of illustration and not limitation, cache(s) 114 comprise one or more regions 115 that, for example, each comprise a respective one or more pages, or a portion of such a page—e.g., wherein each such region comprises a respective plurality of cache lines. In one such embodiment, some or all of region(s) 115 each correspond to a different respective slice of an address space. Alternatively or in addition, cache 116 similarly comprises one or more regions 117 which, for example, each correspond to a different respective slice of an address space.

In an illustrative scenario according to one embodiment, some or all of region(s) 115 and/or some or all of region(s) 117 are dedicated, during operation of processor 110, each to a different respective address slice. By way of illustration and not limitation, region(s) 117 are dedicated each to correspond to a different respective region of system memory 105 (or other such memory coupled to processor 110). Alternatively or in addition, region(s) 115 are dedicated each to correspond to a different respective one of region(s) 117 and/or each to a different respective region of system memory 105. For a given one such cache region, cache lines of the region are to cache only data which is retrieved from—or, alternatively, which is available to be retrieved only to—a memory region which is indicated by a corresponding slice of the address space.

In various embodiments, circuitry of processor 110 is operable to determine an enablement state of a prefetch (or prefetch filter) functionality based on information—referred to herein as an “access history”—which specifies or otherwise indicates a presence or absence of one or more previous accesses which target or otherwise correspond to a given region (e.g., a given page) of a cache or other suitable memory resource. For example, various embodiments maintain access history information for such a region (and, similarly, for a corresponding address slice) as memory accesses are variously performed with processor 110. In an embodiment, some or all such access history is made available as a basis for determining, for example, whether a detected access condition satisfies a criteria for a particular enablement state—e.g., one of an enabled state or a disabled state—of a given type of prefetch (or prefetch filter) functionality.

By way of illustration and not limitation, core 112a further comprises an access tracker 120 to maintain an access history 122 which, for example, includes a record corresponding to a particular one (and only one) memory region, such as a particular one or more pages of a cache or other memory resource. In various embodiments, access history 122 comprises multiple records of access information, each specific to a different respective memory region. In one such embodiment, some or all such records specify or otherwise indicate—e.g., each for a different respective one of region(s) 115, region(s) 117, and/or one or more regions (not shown) in system memory 105—whether the corresponding region has been targeted by any prefetch accesses, whether the corresponding region has been targeted by any demand memory accesses, a relative order in which two or more such access have taken place, and/or the like. In some embodiments, a given one such record identifies particular lines which have been targeted each by a respective access (e.g., one or either of a prefetch access or a demand memory access) in the corresponding region.

In an embodiment, access tracker 120 comprises circuitry which is operable to detect that an access (actual or expected) is to target a particular region—e.g., wherein access tracker 120 is coupled to snoop or otherwise detect an address in an access request. Based on the detected access, access tracker 120 creates, updates or otherwise accesses a corresponding record of access history 122 to register one or more features of the detected memory access. Accordingly, at various times, an enablement state of limiter 142, for example, is subject to being (re)configured, based on access history 122, to determine whether prefetching is to be enabled, disabled, limited or otherwise determined for a given memory region. For example, core 112a further comprises an evaluation unit 130 coupled to access tracker 120, wherein evaluation unit 130 is to detect, based on the access history 122, whether (or not) a given access condition satisfies a criteria for a particular enablement state of a prefetch (or prefetch filter) functionality.

In an illustrative scenario according to some embodiments, a record of access history 122 identifies, for a corresponding region (e.g., a page) of a cache or other suitable memory region, a respective X addresses of said region—where X is some integer greater than one—which were most recently targeted each by a respective demand memory access. In one such embodiment, evaluation unit 130 accesses the record based on the detection of another (e.g., most recent) demand memory access request which targets the region. For example, evaluation unit 130 performs an evaluation to determine whether any of the X most recently targeted addresses of the page is numerically adjacent to the address which is targeted by the demand memory access request in question. Based on the evaluation, evaluation unit 130 signals prefetcher 140 to (re)configure an enablement state of limiter 142.

In this particular context, “numerically adjacent”—also “address adjacent” or, for brevity, merely “adjacent”—refers herein to the characteristic of a difference between a given two different addresses being equal to one (or otherwise being the smallest possible address difference, under the addressing scheme in question). For example, a first address is numerically adjacent to a second address where, in a numerically ordered sequence of addresses, the first address is either a next address after, or a next address before, the second address. It is to be noted that, unless otherwise indicated, “adjacent”, “adjacency” and similar terms, when used in the context of a given two lines (lines of a cache, for example), refer herein to the characteristic of the lines in question corresponding to respective addresses which are numerically adjacent to each other.

In another illustrative scenario according to various embodiments, a record of access history 122 identifies, for a corresponding region, whether or not the region has been targeted by a prefetch access, and whether or not the region has been targeted by a demand memory access. In an embodiment, the record further identifies a particular order of one such prefetch access relative to a corresponding demand memory access. In one such embodiment, evaluation unit 130 accesses the record to detect for an indication that prefetch accesses of the page are sufficiently likely to be followed each by a corresponding demand memory access of the page. Based on the evaluation, evaluation unit 130 signals prefetcher 140 to (re)configure an enablement state of limiter 142—e.g., to enable prefetches which access the page in question.

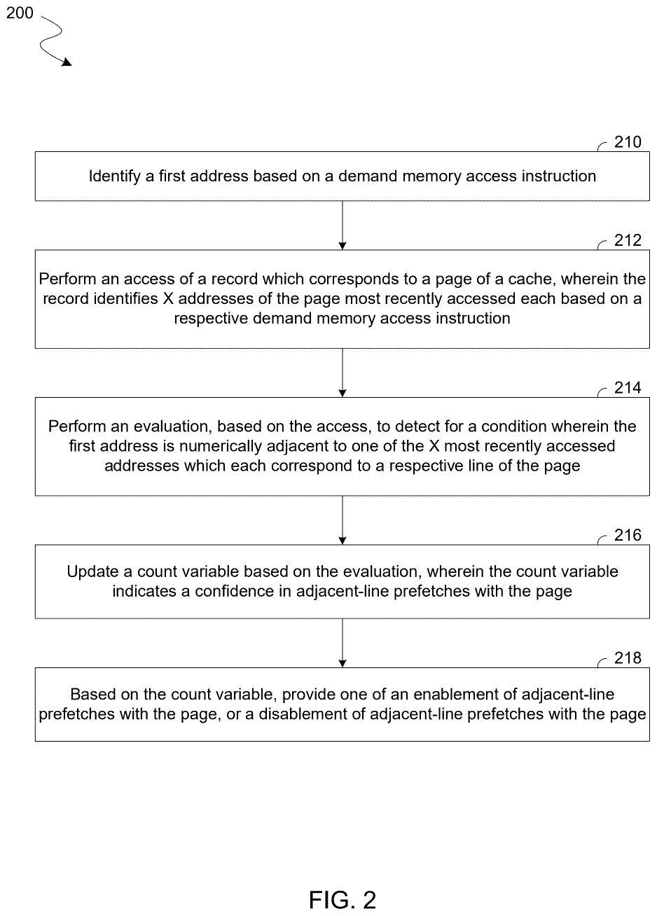

FIG. 2 shows a method 200 for selectively enabling an adjacent-line prefetch filter according to an embodiment. Method 200 illustrates one example of an embodiment wherein a filter, on adjacent-line prefetches that access a given memory resource portion, is selectively imposed or disabled based on a history of previous accesses to that given memory resource portion. Operations such as those of method 200 are performed with any of various combinations of suitable hardware (e.g., circuitry), firmware and/or executing software which, for example, provide some or all of the functionality of processor 110.

As shown in FIG. 2, method 200 comprises (at 210) identifying a first address based on a detected demand memory access instruction. By way of illustration and not limitation, an operand of the demand memory access instruction specifies or otherwise indicates the first address (e.g., includes the first address, or another address which is to be translated into the first address). In a processor at which method 200 is performed, a page of a cache comprises a line which corresponds to the first address—e.g., wherein the first address is an address of the cache line, or an address of a memory location which corresponds to data in the cache line. In some embodiments, the cache is any of various suitable caches such as a level one (L1), level two (L2) or other cache of a processor core, or (alternatively) a shared cache such as a last level cache (LLC) in a cache hierarchy of the processor.

Based on the first address which is identified at 210, method 200 (at 212) performs an access of a record which corresponds to the page. The record specifies or otherwise indicates X addresses (where X is a positive integer greater than one) which, of those addresses which each correspond to a respective line of the page, were most recently accessed each based on a respective demand memory access instruction. For example, the record is one of multiple access history records which each correspond to a different respective cache page, and which each indicate a respective X most recently accessed addresses of the corresponding page. In some embodiments, method 200 further comprises maintaining the record of X addresses—e.g., as the cache is variously accessed during runtime operation of the processor.

Based on the access which is performed at 212, method 200 (at 214) performs an evaluation to detect for a condition (referred to herein as an “address adjacency condition”) wherein the first address is numerically adjacent one of the X most recently accessed addresses which each correspond to a respective line of the page. A given address is understood herein to be “numerically adjacent” to some other address where an absolute value of a difference between the two addresses is equal to one (1).

Based on the evaluation at 214, method 200 (at 216) updates a variable (referred to herein as a “count variable”) which indicates a confidence in adjacent-line prefetches with the page. In an illustrative scenario according to one embodiment, the evaluation at 214 detects a presence of the address adjacency condition, wherein the count variable is incremented or otherwise updated at 216, based on the detected presence, to indicate an increase to the confidence in adjacent-line prefetches with the page. Alternatively, the evaluation at 214 detects an absence of the address adjacency condition, wherein the count variable is decremented or otherwise updated, based on the evaluation, to indicate a decrease to the confidence. Based on the updating of the count variable at 216, method 200 (at 218) performs one of enabling adjacent-line prefetches with the page, or disabling adjacent-line prefetches with the page—e.g., wherein the enabling or disabling is at a page-specific level of granularity.

In some embodiments, adjacent-line prefetches with the page are enabled at 218 based on a determination that the confidence in adjacent-line prefetches with the page satisfies some predefined criteria, such as a minimum threshold level of confidence. Alternatively, adjacent-line prefetches with the page are disabled at 216 based on a determination that the confidence in adjacent-line prefetches with the page fails to satisfy such a minimum threshold criteria. In one such embodiment, a configuration register of the processor is accessed to determine the criteria.

In various embodiments, enabling adjacent-line prefetches with the page at 216 comprises enabling a prefetch of a batch of N lines of the cache page in question, wherein N is a positive integer greater than one, the N lines each correspond to a different respective one of N addresses, and each of the N addresses is numerically adjacent to a respective other one of the N addresses. In one such embodiment, method 200 further comprises accessing a configuration register of the processor to determine the integer N.

In various embodiments, method 200 comprises additional operations (not shown), similar to those described herein, which access a different record—which indicates another X most recently accessed addresses of a different cache page—based on the identification of a second address which corresponds to some other demand memory access instruction. Based on this different record, the additional operations determine whether to update another count variable which corresponds to the different cache page. Furthermore, the additional operations enable or disable adjacent-line prefetches with the different cache page based on said other count variable.

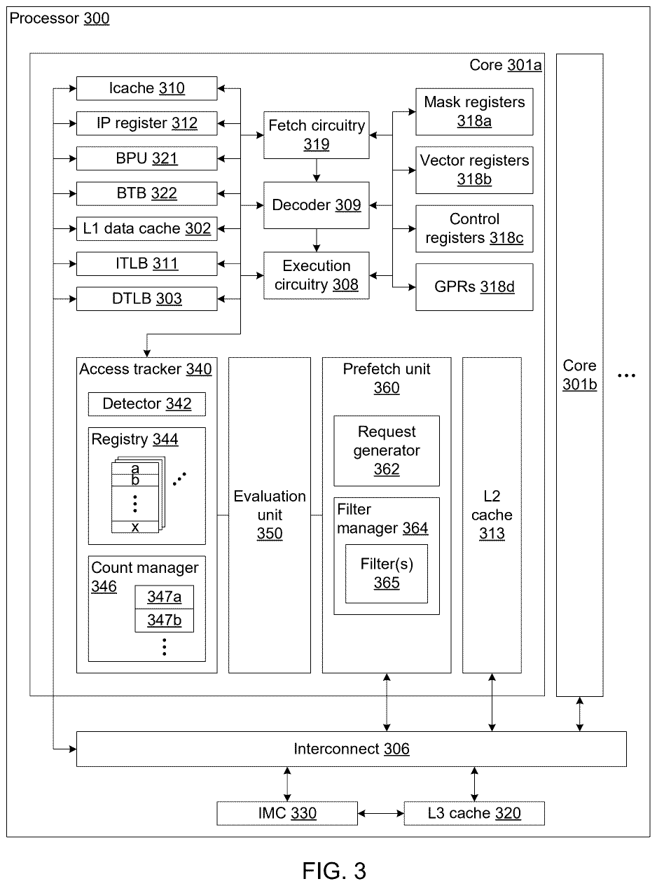

FIG. 3 shows a processor 300 which determines an enablement state of an adjacent-line prefetch filter according to an embodiment. The processor 300 illustrates features of one example embodiment wherein a history of accesses to a given memory resource portion is provided as a basis for determining whether future adjacent-line prefetches are to access that given memory resource portion. In some embodiments, processor 300 provides functionality such as that of processor 110—e.g., wherein operations of method 200 are performed with some or all of processor 300.

As shown in FIG. 3, processor 300 comprises one or more processor cores (e.g., including the illustrative cores 301a, 301b), wherein a shared or “uncore” region of processor 300 comprises data structures and circuitry shared by all or a subset of the cores 301. In the illustrated embodiment, the plurality of cores 301a-b are simultaneous multithreaded cores capable of concurrently executing multiple instruction streams or threads. Although only two cores 301a-b are illustrated in FIG. 3 for simplicity it will be appreciated that the cores 301 may include any number of cores, each of which may include the same architecture as shown for core 301a. Another embodiment includes heterogeneous cores (e.g., low power cores combined with high power/performance cores). In some embodiments, circuitry of processor 300 is adapted from, and/or is incorporated with, any of various suitable processor architectures. By way of illustration and not limitation, any of various suitable embodiments of processor 300 are implemented, for example, in the processor 870 (FIG. 8), the processor/coprocessor 880 (FIG. 8), the processor 900 (FIG. 9), the pipeline 1000 (FIG. 10A), and/or the core 1090 (FIG. 10B).

In the example embodiment shown, a given one of cores 301 includes instruction pipeline components for performing out-of-order (or in-order) execution of one or more instruction streams. By way of illustration and not limitation, such components comprise instruction fetch circuitry 319 which, for example, fetches instructions from system memory (not shown) or the instruction cache 310, and a decoder 309 comprising circuitry which decodes the fetched instructions. Execution circuitry 308 executes the decoded instructions to perform the underlying operations, as specified by the instruction operands, opcodes, and any immediate values.

Also illustrated in FIG. 3 are general purpose registers (GPRs) 318d, a set of vector registers 318b, a set of mask registers 318a, and a set of control registers 318c. In one embodiment, multiple vector data elements are packed into each vector register 318c which, for example, have a 512 bit width for storing two 256 bit values, four 128 bit values, eight 64 bit values, sixteen 32 bit values, etc. However, various embodiments are not limited to any particular size/type of vector data. In one embodiment, the mask registers 318a include eight 64-bit operand mask registers used for performing bit masking operations on the values stored in the vector registers 318c (e.g., implemented as mask registers k0-k7 described above). However, various embodiments are not limited to any particular mask register size/type.

The control registers 318c store various types of control bits or “flags” which are used by executing instructions to determine the current state of the processor core 301a. By way of example, and not limitation, in an x86 architecture, the control registers include the EFLAGS register.

An interconnect 306 such as an on-die interconnect (IDI) implementing an IDI/coherence protocol communicatively couples the cores 301a-b to one another and to various components within the shared region of processor 300. For example, the interconnect 306 couples core 301a to a level 3(L3 ) cache 320 and an integrated memory controller (IMC) 330 which couples the processor to a system memory (not shown).

IMC 330 provides access to a system memory when performing memory operations (e.g., such as a MOV from system memory to a register). One or more input/output (I/O) circuits (not shown) such as PCI express circuitry (for example) are additionally or alternatively included in the shared region, in some embodiments.

An instruction pointer (IP) register 312 stores an instruction pointer address identifying the next instruction to be fetched, decoded, and executed. Instructions may be fetched or prefetched from system memory and/or one or more shared cache levels such as an L2 cache 313, the shared L3 cache 320, or the L1 instruction cache 310. In addition, an L1 data cache 302 stores data loaded from system memory and/or retrieved from one of the other cache levels 313, 320 which cache both instructions and data. An instruction translation lookaside buffer (ITLB) 311 stores virtual address to physical address translations for the instructions fetched by the fetch circuitry 319 and a data translation lookaside buffer (DTLB) 303 stores virtual-to-physical address translations for the data processed by the decoder 309 and execution circuitry 308.

FIG. 3 also illustrates a branch prediction unit (BPU) 321 for speculatively predicting instruction branch addresses and one or more branch target buffers—e.g., including the illustrative branch target buffer (BTB) 322 shown—for storing branch addresses and target addresses. In one embodiment, a branch history table (not shown) or other data structure is maintained and updated for each branch prediction/misprediction and is used by BPU 321 to make subsequent branch predictions.

Note that FIG. 3 is not intended to provide a comprehensive view of all circuitry and interconnects employed within a processor. Rather, components which are not pertinent to the embodiments of the invention are not shown. Conversely, some components are shown merely for the purpose of providing an example architecture in which embodiments of the invention may be implemented.

There has been extensive work on prefetching in both industry and academia over the years. Various types of prefetchers are available, and adapting one such prefetcher in a given processor design typically involves one or more trade-offs between resource complexity, timely coverage, and accuracy. Accordingly, different prefetches usually exhibit one or more relative disadvantages and/or sub-optimal characteristics in various ways.

For example, a streamer prefetcher looks for a directional trend and issues prefetches a fixed distance (8 or 16 cachelines) away from a triggering access. It does not efficiently capture non-uniform (non-streaming) access patterns to a page and is highly inaccurate in a number of cases. Spatial Memory Streaming (SMS) prefetching associates a signature—a triggering program counter (PC) and offset to a page—with an entire 64 bit pattern of subsequent accesses to the page. While more accurate and timely than Streamer prefetchers, SMS still has some major drawbacks related to area and coverage/accuracy.

A Signature Pattern Prefetcher (SP) is capable of dealing with complex non-uniform access patterns in a page. Timeliness of prefetches however is limited. Without the use of a triggering PC, it has a limited mechanism for triggering prefetches on the first access to the page. It achieves prefetch distance on subsequent accesses through a series of recursive predictions, each of lower confidence or accuracy, finally bound by a lower limit on confidence. This again puts a limit on prefetch timeliness.

To facilitate the determining of an enablement state for a prefetch filter, core 301a further comprises an access tracker 340, an evaluation unit 350, and a prefetch unit 360 which—for example—correspond functionally to access tracker 120, evaluation unit 130, and prefetcher 140 (respectively). Access tracker 340 comprises a detector 342 which is coupled to detect, for each of one or more pages (or other suitable memory regions), a respective access (if any) of said page. For a given one such page, detector 342 is able to detect either a prefetch access or a demand memory access.

In an illustrative scenario according to one embodiment, detector 342 identifies an address based on a demand memory access instruction (or alternatively, based on a prefetch request), wherein a page of a cache comprises a line which corresponds to the address. Based on the first address, detector 342 signals a registry 344 of access tracker 340 (e.g., the registry 344 comprising a repository of access history 122) to create, update, or otherwise access a record which corresponds to the page in question. In an embodiment, a given one such record of registry 344 is to be maintained to identify X addresses (where X is a positive integer greater than one) which, of those addresses which each indicates a respective line of the corresponding page, were most recently accessed each based on a respective demand memory access instruction.

At some point during operation of core 301a, a count manager 346 of access tracker 340 performs an evaluation, based on a given record of registry 344, to detect for a condition—referred to herein as an “address adjacency condition”, or simply an “adjacency condition”—wherein any address, of the X most recently demand memory accessed addresses for a corresponding page, is numerically adjacent to an address in another (e.g., pending) demand memory access request. Based on the evaluation, count manager 346 updates a variable (referred to herein as a “count variable”) which corresponds to the page in question, wherein the variable indicates a confidence in adjacent-line prefetches with the page.

In an illustrative scenario according to one embodiment, count manager 346 maintains a count variable 347a which corresponds to a first cache page, a count variable 347b which corresponds to a second cache page, etc. In one such embodiment, where an evaluation based on a first record of registry 344 indicates a presence of an adjacency condition at the first page, count manager 346 increments or otherwise updates the count variable 347a to indicate an increase to a confidence in adjacent-line prefetches which are to access the first page. By contrast, where such an evaluation based on the first record of registry 344 indicates an absence of an adjacency condition at the first page, count manager 346 instead decrements or otherwise updates the count variable 347a to indicate a decrease to the confidence in adjacent-line prefetches which are to access the first page.

In an embodiment, evaluation unit 350 monitors one or more count variables which are maintained with count manager 346 to determine, based on a given one such count variable, whether an adjacent-line prefetch functionality for a corresponding page is to be (re)configured. As used herein, “adjacent-line prefetch” refers to a prefetch which accesses a given first line, wherein the access is automatically performed based on a demand memory access of a second line which is address adjacent to the first line (i.e., wherein the first line and the second line correspond to respective addresses which are numerically adjacent to each other).

For example, evaluation unit 350 makes a determination as to whether (or not) a given count variable satisfies a corresponding confidence metric, where—based on the determination—evaluation unit 350 conditionally signals a filter manager 364 of prefetch unit 360 to enable of disable a prefetch filter (e.g., of the illustrative one or more filters 365 shown) which corresponds to the page in question. In an embodiment, a request generator 362 of prefetch unit 360 generates various requests—e.g., including adjacent-line prefetch requests—which are each to prefetch data to or from a respective cache page. For a given one such page, the generation (or alternatively, the processing) of adjacent-line prefetch requests which target that page is prevented or otherwise limited when a corresponding adjacent-line prefetch filter of the filter(s) 365 is in an enabled state.

In an embodiment, evaluation unit 350 determines that count variable 347a (for example) indicates an adjacent-line prefetch confidence level which satisfies a minimum threshold criteria. Based on such a determination, evaluation unit 350 signals filter manager 364 to disable a corresponding one of filter(s) 365 (e.g., unless said filter is already disabled), thereby enabling adjacent-line prefetches which target the corresponding page. Alternatively or in addition, responsive to evaluation unit 350 determining that the indicated adjacent-line prefetch confidence level fails to satisfy the minimum threshold criteria, filter manager 364 enables the corresponding one of filter(s) 365, thereby preventing or otherwise limiting adjacent-line prefetches which target the corresponding page. In one such embodiment, the minimum threshold criteria in question is programmed or otherwise provided at one of control registers 318c, or at any of various other suitable configuration registers of processor 300.

In some embodiments, the enabling of an adjacent-line prefetch functionality enables an automatic prefetching of more than one lines of the region (such as a cache page) in question. In one such embodiment, disabling a given one of filter(s) 365 enables a prefetch of N lines of a page (wherein N is a positive integer greater than one) based on a single direct memory access of the same page, wherein the N lines each correspond to a different respective one of N addresses, and wherein each of the N addresses is numerically adjacent to a respective other one of the N addresses. In one such embodiment, the value of N is programmed or otherwise provided at one of control registers 318c, or at any of various other suitable configuration registers of processor 300.

In some embodiments, a given adjacent-line prefetch filter is specific to one or more cache pages and/or is specific to one count variable. Additionally or alternatively, an adjacent-line prefetch filter for a given cache page is to be distinguished, for example, from one or more other prefetch filters (if any) which—when enabled—are to prevent or otherwise limit prefetches, other than adjacent-line prefetches, which would otherwise access the given cache page.

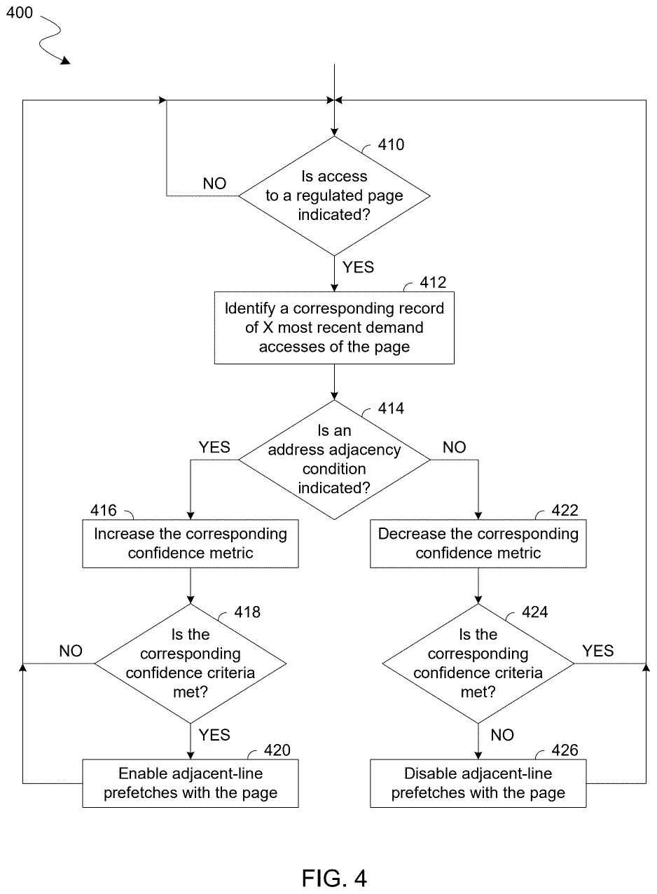

FIG. 4 shows a method 400 for determining respective enablement states of region-specific adjacent-line prefetch filters according to an embodiment. Method 400 illustrates one example of an embodiment wherein access history records are maintained, each for a corresponding page of a memory resource, to facilitate the selective filtering of prefetches which, otherwise, would each access a respective one such page. Operations such as those of method 400 are performed with any of various combinations of suitable hardware (e.g., circuitry), firmware and/or executing software which, for example, provide some or all of the functionality of processor 110 or processor 300—e.g., wherein operations of method 200 include or are otherwise based on method 400.

As shown in FIG. 4, method 400 comprises performing an evaluation (at 410) to determine whether a regulated page—i.e., a page for which adjacent-line prefetch functionality is subject to being enabled or disabled—has been recently accessed. In this particular context, “newly accessed” refers to an access which has not been detected at a preceding evaluation (if any) at 410, or which has otherwise yet to be a basis for method 400 updating a corresponding confidence metric.

Where it is determined at 410 that no regulated page has been newly accessed, method 400 performs another evaluation (at 410)—e.g., until an access of a regulated page is detected. Where it is instead determined at 410 that a regulated page has been newly accessed, method 400 (at 412) identifies a corresponding access history record which identifies a respective X most recent demand accesses of the page in question (where X is some integer greater than one). For example, the corresponding access history record specifies or otherwise indicates addresses each corresponding to a different respective one of the X most recently demand accessed lines of the page in question.

Method 400 further comprises performing an evaluation (at 414) to determine, based on the identified access history record, whether an address adjacency condition is indicated. Where an address adjacency condition is detected at 414, method 400 (at 416) increases a confidence metric which corresponds to the newly accessed page. After increasing the confidence metric at 416, method 400 performs another evaluation (at 418) to determine whether the recently increased confidence metric currently satisfies a confidence criteria which corresponds to the page. For example, the confidence criteria includes, or is otherwise based on, a threshold minimum number of recent address adjacency conditions which are required as a condition for adjacent-line prefetching to be enabled.

Where it is determined at 418 that the confidence metric does not currently satisfy the confidence criteria, method 400 performs a next instance of the evaluating at 410. Where it is instead determined at 418 that the corresponding confidence criteria is satisfied, method 400 (at 420) enables adjacent-line prefetches which access the page. After the enabling at 420, method 400 performs a next instance of the evaluating at 410.

Where it is instead determined at 414 that no address adjacency condition is indicated, method 400 decreases the corresponding confidence metric (at 422). After decreasing the confidence metric at 422, method 400 performs another evaluation (at 424) to determine whether the recently increased confidence metric currently satisfies the confidence criteria which corresponds to the page.

Where it is determined at 424 that the corresponding confidence criteria is satisfied, method 400 performs a next instance of the evaluating at 410. Where it is instead determined at 424 that the confidence metric does not currently satisfy the confidence criteria, method 400 (at 26) disables adjacent-line prefetches which access the page. After the disabling at 426, method 400 performs a next instance of the evaluating at 410.

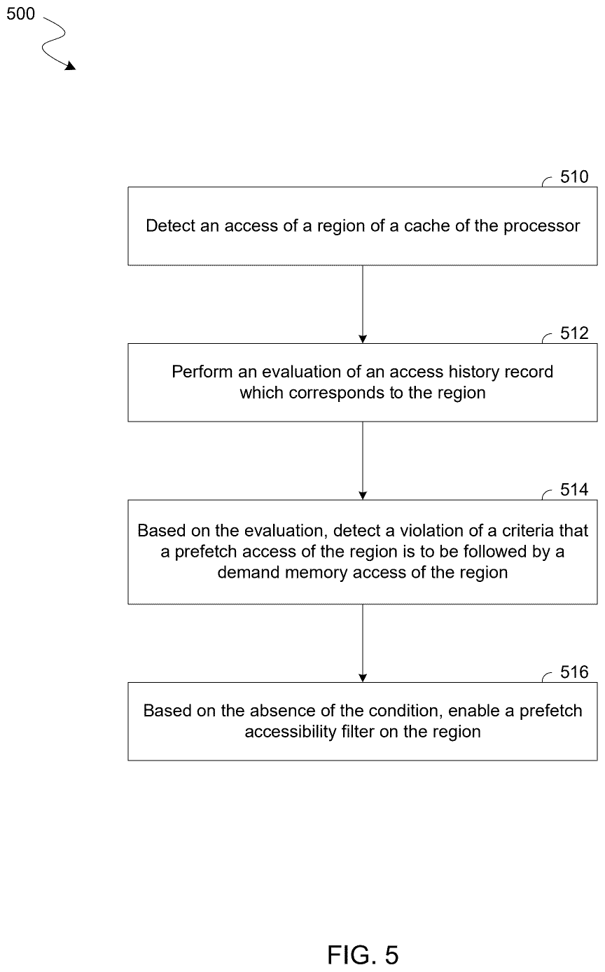

FIG. 5 shows a method 500 for selectively enabling a region-specific prefetch filter based on an access history according to an embodiment. Method 500 illustrates one example of an embodiment wherein a given memory region is made accessible by future prefetches based on whether that same memory region has been subject to a previous demand memory access and a previous prefetch access. Operations such as those of method 500 are performed with any of various combinations of suitable hardware (e.g., circuitry), firmware and/or executing software which, for example, provide some or all of the functionality of processor 110.

As shown in FIG. 5, method 500 comprises (at 510) detecting an access of a region of a cache of the processor. In an embodiment, the cache is shared by multiple cores of the processor. Alternatively or in addition, the cache is (for example) a last level cache in a cache hierarchy of the processor. Based on the detecting of the access at 510, method 500 (at 512) performs an evaluation of an access history record which corresponds to the region. The evaluating at 512 is to determine, for example, whether a history of accesses of the region satisfy a criteria according to which prefetch filtering is to be enabled (or alternatively, disabled)—e.g., at a region-specific level of granularity.

In an illustrative scenario according to one embodiment, the access history record comprises one or more fields to specify or otherwise indicate, for example, whether the corresponding region has been targeted by (or otherwise the subject of) any demand memory access since a creation of the access history record. Alternatively or in addition, the one or more fields specify or otherwise indicate whether the corresponding region has been a subject of any prefetch access since the creation of the access history record. In one such embodiment, the one or more fields further specify or otherwise indicate, for those instances where the region has been subjected both to a demand memory access and to a prefetch access, a relative order of a time of the demand memory access and a time of the prefetch access. In various embodiments, the access history record has, at the time of evaluation at 512, been updated to indicate the access detected at 512. In some embodiments, method 500 further comprises operations (not shown) which maintain the corresponding access history record—e.g., as cache accesses take place during runtime operation of the processor.

Based on the evaluation at 512, method 500 (at 514) detects a violation of a criteria—referred to herein as a “prefetch-then-demand criteria”—the violation of which, if any, is to be a basis for enabling a prefetch filter. By way of illustration and not limitation, such a prefetch-then-demand criteria is satisfied where a prefetch access to the memory region is followed (e.g., within some limit such as a threshold maximum number of processing cycles) by a corresponding demand memory access of the region. By contrast, the prefetch-then-demand criteria is violated where (for example) such a prefetch access of the memory region is preceded by the corresponding demand memory access of the region. In various embodiments, a prefetch-then-demand criteria is not violated—that is, at least not yet violated—where, for example, a demand memory access of a given memory region does not correspond to any prefetch access of that memory region (e.g., at least not one within some limit such as a threshold number of processing cycles). Alternatively or in addition, a prefetch-then-demand criteria is not violated, at least not yet, where a prefetch access of a given memory region does not correspond to any demand memory access of that memory region (e.g., at least not one within some limit such as a threshold number of processing cycles). In an embodiment, the evaluating at 512 is to detect whether prefetches which access the cache region in question are (in)effective, or whether there has not yet been enough accessing of the region to establish such (in)effectiveness.

In some embodiments, an evaluation to test for the presence or absence of a prefetch-then-demand criteria violation is limited to those evaluating those accesses of a given cache region (if any) which have occurred since the creation of an access history record which corresponds to that cache region. In various embodiments, such an access history record is created based on a determination that the cache—e.g., at least a region thereof—has begun to represent (e.g., begun to include cached versions of data in) a particular page, or other suitable region, of system memory.

Based on the violation detected at 514, method 500 (at 516) enables a prefetch accessibility filter on the region. In an embodiment, the enabling at 516 makes the region inaccessible by prefetches—e.g., wherein requests for prefetch access to the region are prevented from being generated, are rejected, and/or the like.

In some embodiments, method 500 comprises additional operations (not shown), similar to those described herein, which—based on a second access of the same cache region—perform a second evaluation of the access history record to detect whether (or not) the same prefetch-then-demand criteria is currently violated. In one such embodiment, the second evaluation detects a satisfaction of the prefetch-then-demand criteria, wherein—based on said satisfaction—method 500 disables the prefetch accessibility filter on the region. In another embodiment, the prefetch accessibility filter on that region, once enabled, remains enabled until the corresponding access history record is deleted, invalidated or otherwise made unavailable - e.g., based on the cache region no longer representing a particular memory page, a particular slice of an address space, or other such resource to which the access history record corresponds. In an embodiment, the prefetch accessibility filter is specific to the cache region (e.g., wherein one or more other prefetch accessibility filter are able to be variously enabled or disabled each to prevent or allow prefetch access to a respective other region of the cache).

In various embodiments, method 500 additionally or alternatively comprises additional operations (not shown), similar to those described herein, which evaluate another history access history record based on an access to a different region of the same cache or, alternatively, of some other cache. In an illustrative scenario according to one embodiment, this other evaluation detects whether (or not) a prefetch-then-demand criteria which corresponds to the different cache region is currently violated. In one such embodiment, this other evaluation detects a violation of the corresponding prefetch-then-demand criteria, wherein—based on said violation—method 500 enables a prefetch accessibility filter on the different cache region. Alternatively, the other evaluation detects a satisfaction of corresponding prefetch-then-demand criteria, wherein—based on said satisfaction—method 500 disables the prefetch accessibility filter on the different cache region.

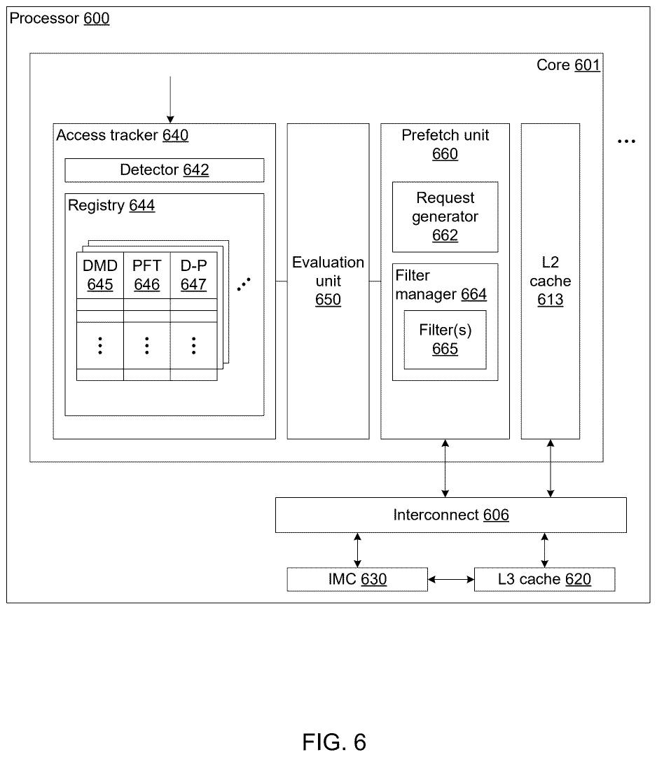

FIG. 6 shows a processor 600 which determines an enablement state of a region-specific prefetch filter based on an access history according to an embodiment. Processor 600 illustrates features of one example embodiment wherein a region-specific prefetch filter is enabled (or disabled) based on whether a corresponding memory region has previously been subjected both to a demand memory access and to a prefetch access. In some embodiments, processor 600 provides functionality such as that of processor 110—e.g., wherein operations of method 500 are performed with some or all of processor 600.

As shown in FIG. 6, processor 600 comprises a core 601, an integrated memory controller (IMC) 630, and an L3 cache 620 which (for example) correspond functionally to core 301, IMC 330, and an L3 cache 320. An interconnect 606 of processor 600 couples IMC 630 and shared L3 cache 620 to various circuits of core 601—e.g., including an L2 cache 613 and other circuitry which, for example, variously provides functionality of core 301a. In some embodiments, circuitry of processor 600 is adapted from, and/or is incorporated with, any of various suitable processor architectures. By way of illustration and not limitation, any of various suitable embodiments of processor 600 are implemented, for example, in the processor 870 (FIG. 8), the processor/coprocessor 880 (FIG. 8), the processor 900 (FIG. 9), the pipeline 1000 (FIG. 10A), and/or the core 1090 (FIG. 10B).

To facilitate the determining of an enablement state for a prefetch filter, core 601 comprises an access tracker 640, an evaluation unit 650, and a prefetch unit 660 which—for example—provide functionality similar to that of access tracker 120, evaluation unit 130, and prefetcher 140 (respectively). Access tracker 640 comprises a detector 642 and a registry 644 which, for example, provide functionality similar to that of detector 342 and registry 344 (respectively). Furthermore, prefetch unit 660 comprises a request generator 662 and a filter manager 664 which, for example, provide functionality similar to that of request generator 362 and filter manager 364 (respectively).

Detector 642 is operable to detect an access of a region of a cache (e.g., L2 cache 613 or shared L3 cache 620) of processor 600. Based on the access detected by detector 642, evaluation unit 650 accesses registry 644 to read an access history record which corresponds to the region. Evaluation unit 650 performs an evaluation of the access history record to detect for the satisfaction, or violation, of a criteria (referred to herein as a “prefetch-then-demand criteria”), according to which a prefetch access of the region in question is to be followed by a corresponding demand memory access of that region.

By way of illustration and not limitation, such a record includes a demand field DMD 645 which is to indicate whether a demand memory access of the region has previously been detected. Furthermore, said record includes a prefetch field PFT 646 which is to indicate whether a prefetch access of the region has previously been detected. Further still, said record includes a field D-P 647 which is to indicate a relative order of the demand memory access (if any) and the prefetch access (if any). Based on such fields, some embodiments variously enable evaluation unit 650 to determine, for a given page, whether accesses to the page (if any) have satisfied or violated a prefetch-then-demand criteria.

Where the evaluation by evaluation unit 650 detects a violation of the prefetch-then-demand criteria for the accessed region, evaluation unit 650 signals filter manager 664 to enable a prefetch filter (e.g., of the one or more prefetch filters 665 shown) which is to filter prefetch accessing of the region. In one such embodiment, the prefetch filter is initially disabled—e.g., at least upon some reference event (such as a creation of the corresponding record in registry 644)—and remains so until enough accesses of the page in question have been performed to determine whether the corresponding prefetch-then-demand criteria has been satisfied or violated.

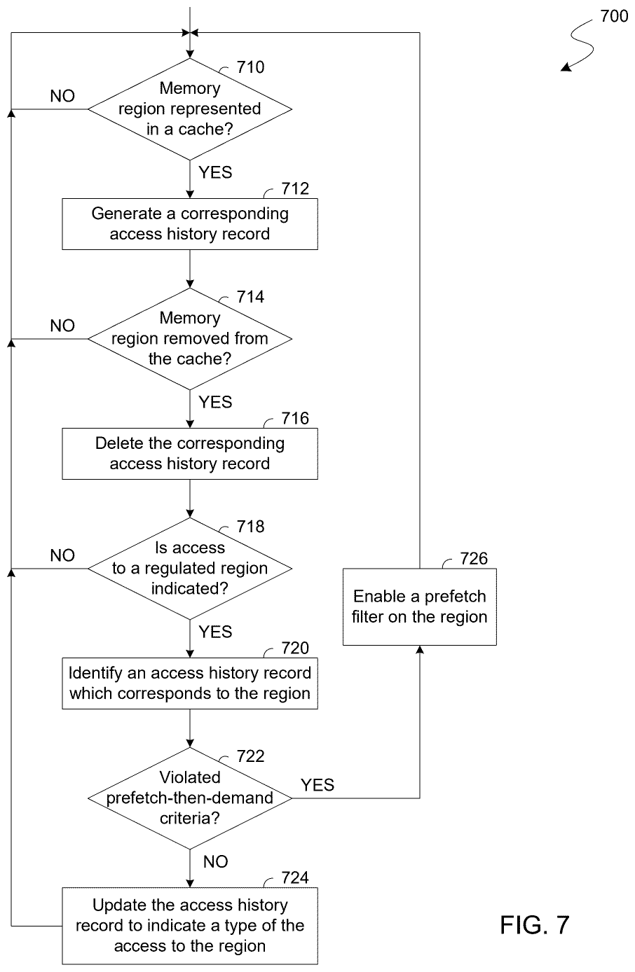

FIG. 7 shows a method 700 for determining enablement states of region-specific prefetch filters based on respective access histories according to an embodiment. Operations such as those of method 700 are performed with any of various combinations of suitable hardware (e.g., circuitry), firmware and/or executing software which, for example, provide some or all of the functionality of processor 110 or processor 600—e.g., wherein operations of method 500 include, or are otherwise based on, method 700.

As shown in FIG. 7, method 700 comprises performing an evaluation (at 710) to determine whether any memory region is newly represented in a cache. Where it is determined at 710 that not such new memory region is represented in the cache, method 700 performs a next instance of the evaluating at 710—e.g., until a newly represented memory region is detected. Where it is instead determined at 710 that a memory region is newly represented in the cache, method 700 (at 712) generates an access history record which corresponds to the memory region most recently detected at 710.

Method 700 further comprises performing an evaluation (at 714) to determine whether any memory region has newly been removed from representation in the cache. Where it is determined at 714 that no such memory region has been removed from cache representation, method 700 performs a next instance of the evaluating at 710. Where it is instead determined at 714 that some memory region is no longer represented in the cache, method 700 (at 716) deletes (or, for example, invalidates) an access history record which corresponds to the removed memory region most recently detected at 714.

Method 700 further comprises performing an evaluation (at 718) to determine whether any regulated memory region (i.e., a region for which prefetch access is regulated) has been newly accessed. In this particular context, “newly accessed” refers to an access which has not yet been detected at a preceding evaluation (if any) at 718, or which has otherwise yet to be a basis for method 700 determining whether a corresponding prefetch filter is to be enabled. Where it is determined at 718 that no such memory region has been newly accessed, method 700 performs a next instance of the evaluating at 710. Where it is instead determined at 718 that such a memory region has been newly accessed, method 700 (at 720) identifies an access history record which corresponds to that accessed memory region.

Method 700 further comprises performing an evaluation (at 722) to determine, based on the access history record most recently identified at 720, whether a prefetch-then-demand criteria has been violated by the accessing of the memory region in question. By way of illustration and not limitation, such a prefetch-then-demand criteria is satisfied where a prefetch access to the memory region is followed (e.g., within some limit such as a threshold maximum number of processing cycles) by a corresponding demand memory access of the region. By contrast, the prefetch-then-demand criteria is violated where (for example) such a prefetch access of the memory region being preceded by the corresponding demand memory access of the region. In various embodiments, a prefetch-then-demand criteria is not violated—that is, at least not yet violated—where, for example, a demand memory access of a given memory region does not correspond to any prefetch access of that memory region (e.g., at least not one within some limit such as a threshold number of processing cycles). Alternatively or in addition, a prefetch-then-demand criteria is not violated, at least not yet, where a prefetch access of a given memory region does not correspond to any demand memory access of that memory region (e.g., at least not one within some limit such as a threshold number of processing cycles).

Where it is determined at 722 that no such prefetch-then-demand criteria has been violated, method 700 (at 724) updates the access history record to indicate an access type for the region access most recently detected at 718. After the updating at 724, method 700 performs a next instance of the evaluating at 710. Where it is instead determined at 722 that the prefetch-then-demand criteria has been violated, method 700 (at 726) enables a prefetch filter on the memory region in question. After the enabling at 726, method 700 performs a next instance of the evaluating at 710.

### Exemplary Computer Architectures

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 8 illustrates an exemplary system. Multiprocessor system 800 is a point-to-point interconnect system and includes a plurality of processors including a first processor 870 and a second processor 880 coupled via a point-to-point interconnect 850. In some examples, the first processor 870 and the second processor 880 are homogeneous. In some examples, first processor 870 and the second processor 880 are heterogenous. Though the exemplary system 800 is shown to have two processors, the system may have three or more processors, or may be a single processor system.

Processors 870 and 880 are shown including integrated memory controller (IMC) circuitry 872 and 882, respectively. Processor 870 also includes as part of its interconnect controller point-to-point (P-P) interfaces 876 and 878; similarly, second processor 880 includes P-P interfaces 886 and 888. Processors 870, 880 may exchange information via the point-to-point (P-P) interconnect 850 using P-P interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a chipset 890 via individual P-P interconnects 852, 854 using point to point interface circuits 876, 894, 886, 898. Chipset 890 may optionally exchange information with a coprocessor 838 via an interface 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via P-P interconnect, such that either or both processors'local cache information may be stored in the shared cache if a processor is placed into a low power mode.

Chipset 890 may be coupled to a first interconnect 816 via an interface 896. In some examples, first interconnect 816 may be a Peripheral Component Interconnect (PCI) interconnect, or an interconnect such as a PCI Express interconnect or another I/O interconnect. In some examples, one of the interconnects couples to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interconnect 816, along with a bus bridge 818 which couples first interconnect 816 to a second interconnect 820. In some examples, one or more additional processor(s) 815, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 816. In some examples, second interconnect 820 may be a low pin count (LPC) interconnect. Various devices may be coupled to second interconnect 820 including, for example, a keyboard and/or mouse 822, communication devices 827 and a storage circuitry 828. Storage circuitry 828 may be one or more non-transitory machine-readable storage media as described below, such as a disk drive or other mass storage device which may include instructions/code and data 830 in some examples. Further, an audio I/O 824 may be coupled to second interconnect 820. Note that other architectures than the point-to-point architecture described above are possible. For example, instead of the point-to-point architecture, a system such as multiprocessor system 800 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

FIG. 9 illustrates a block diagram of an example processor 900 that may have more than one core and an integrated memory controller. The solid lined boxes illustrate a processor 900 with a single core 902A, a system agent unit circuitry 910, a set of one or more interconnect controller unit(s) circuitry 916, while the optional addition of the dashed lined boxes illustrates an alternative processor 900 with multiple cores 902A-N, a set of one or more integrated memory controller unit(s) circuitry 914 in the system agent unit circuitry 910, and special purpose logic 908, as well as a set of one or more interconnect controller units circuitry 916. Note that the processor 900 may be one of the processors 870 or 880, or co-processor 838 or 815 of FIG. 8.

Thus, different implementations of the processor 900 may include: 1) a CPU with the special purpose logic 908 being integrated graphics and/or scientific (throughput) logic (which may include one or more cores, not shown), and the cores 902A-N being one or more general purpose cores (e.g., general purpose in-order cores, general purpose out-of-order cores, or a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 904A-N within the cores 902A-N, a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4(L4 ), or other levels of cache, such as a last level cache (LLC), and/or combinations thereof. While in some examples ring-based interconnect network circuitry 912 interconnects the special purpose logic 908 (e.g., integrated graphics logic), the set of shared cache unit(s) circuitry 906, and the system agent unit circuitry 910, alternative examples use any number of well-known techniques for interconnecting such units. In some examples, coherency is maintained between one or more of the shared cache unit(s) circuitry 906 and cores 902A-N.

In some examples, one or more of the cores 902A-N are capable of multi-threading. The system agent unit circuitry 910 includes those components coordinating and operating cores 902A-N. The system agent unit circuitry 910 may include, for example, power control unit (PCU) circuitry and/or display unit circuitry (not shown). The PCU may be or may include logic and components needed for regulating the power state of the cores 902A-N and/or the special purpose logic 908 (e.g., integrated graphics logic). The display unit circuitry is for driving one or more externally connected displays.

The cores 902A-N may be homogenous in terms of instruction set architecture (ISA). Alternatively, the cores 902A-N may be heterogeneous in terms of ISA; that is, a subset of the cores 902A-N may be capable of executing an ISA, while other cores may be capable of executing only a subset of that ISA or another ISA.

### Exemplary Core Architectures-in-Order and Out-of-Order Core Block Diagram

FIG. 10A is a block diagram illustrating both an exemplary in-order pipeline and an exemplary register renaming, out-of-order issue/execution pipeline according to examples. FIG. 10B is a block diagram illustrating both an exemplary example of an in-order architecture core and an exemplary register renaming, out-of-order issue/execution architecture core to be included in a processor according to examples. The solid lined boxes in FIGS. 10A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10A, a processor pipeline 1000 includes a fetch stage 1002, an optional length decoding stage 1004, a decode stage 1006, an optional allocation (Alloc) stage 1008, an optional renaming stage 1010, a schedule (also known as a dispatch or issue) stage 1012, an optional register read/memory read stage 1014, an execute stage 1016, a write back/memory write stage 1018, an optional exception handling stage 1022, and an optional commit stage 1024. One or more operations can be performed in each of these processor pipeline stages. For example, during the fetch stage 1002, one or more instructions are fetched from instruction memory, and during the decode stage 1006, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1006 and the register read/memory read stage 1014 may be combined into one pipeline stage. In one example, during the execute stage 1016, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 10B may implement the pipeline 1000 as follows: 1) the instruction fetch circuitry 1038 performs the fetch and length decoding stages 1002 and 1004; 2) the decode circuitry 1040 performs the decode stage 1006; 3) the rename/allocator unit circuitry 1052 performs the allocation stage 1008 and renaming stage 1010; 4) the scheduler(s) circuitry 1056 performs the schedule stage 1012; 5) the physical register file(s) circuitry 1058 and the memory unit circuitry 1070 perform the register read/memory read stage 1014; the execution cluster(s) 1060 perform the execute stage 1016; 6) the memory unit circuitry 1070 and the physical register file(s) circuitry 1058 perform the write back/memory write stage 1018; 7) various circuitry may be involved in the exception handling stage 1022; and 8) the retirement unit circuitry 1054 and the physical register file(s) circuitry 1058 perform the commit stage 1024.

FIG. 10B shows a processor core 1090 including front-end unit circuitry 1030 coupled to an execution engine unit circuitry 1050, and both are coupled to a memory unit circuitry 1070. The core 1090 may be a reduced instruction set architecture computing (RISC) core, a complex instruction set architecture computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front end unit circuitry 1030 may include branch prediction circuitry 1032 coupled to an instruction cache circuitry 1034, which is coupled to an instruction translation lookaside buffer (TLB) 1036, which is coupled to instruction fetch circuitry 1038, which is coupled to decode circuitry 1040. In one example, the instruction cache circuitry 1034 is included in the memory unit circuitry 1070 rather than the front-end circuitry 1030. The decode circuitry 1040 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1040 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1040 may be implemented using various different mechanisms. Examples of suitable mechanisms include, but are not limited to, look-up tables, hardware implementations, programmable logic arrays (PLAs), microcode read only memories (ROMs), etc. In one example, the core 1090 includes a microcode ROM (not shown) or other medium that stores microcode for certain macroinstructions (e.g., in decode circuitry 1040 or otherwise within the front end circuitry 1030). In one example, the decode circuitry 1040 includes a micro-operation (micro-op) or operation cache (not shown) to hold/cache decoded operations, micro-tags, or micro-operations generated during the decode or other stages of the processor pipeline 1000. The decode circuitry 1040 may be coupled to rename/allocator unit circuitry 1052 in the execution engine circuitry 1050.

The execution engine circuitry 1050 includes the rename/allocator unit circuitry 1052 coupled to a retirement unit circuitry 1054 and a set of one or more scheduler(s) circuitry 1056. The scheduler(s) circuitry 1056 represents any number of different schedulers, including reservations stations, central instruction window, etc. In some examples, the scheduler(s) circuitry 1056 can include arithmetic logic unit (ALU) scheduler/scheduling circuitry, ALU queues, arithmetic generation unit (AGU) scheduler/scheduling circuitry, AGU queues, etc. The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1058 includes vector registers unit circuitry, writemask registers unit circuitry, and scalar register unit circuitry. These register units may provide architectural vector registers, vector mask registers, general-purpose registers, etc. The physical register file(s) circuitry 1058 is coupled to the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution unit(s) circuitry 1062 and a set of one or more memory access circuitry 1064. The execution unit(s) circuitry 1062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1056, physical register file(s) circuitry 1058, and execution cluster(s) 1060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1064). It should also be understood that where separate pipelines are used, one or more of these pipelines may be out-of-order issue/execution and the rest in-order.

In some examples, the execution engine unit circuitry 1050 may perform load store unit (LSU) address/data pipelining to an Advanced Microcontroller Bus (AMB) interface (not shown), and address phase and writeback, data phase load, store, and branches.

The set of memory access circuitry 1064 is coupled to the memory unit circuitry 1070, which includes data TLB circuitry 1072 coupled to a data cache circuitry 1074 coupled to a level 2 (L2) cache circuitry 1076. In one exemplary example, the memory access circuitry 1064 may include a load unit circuitry, a store address unit circuit, and a store data unit circuitry, each of which is coupled to the data TLB circuitry 1072 in the memory unit circuitry 1070. The instruction cache circuitry 1034 is further coupled to the level 2 (L2) cache circuitry 1076 in the memory unit circuitry 1070. In one example, the instruction cache 1034 and the data cache 1074 are combined into a single instruction and data cache (not shown) in L2 cache circuitry 1076, a level 3 (L3) cache circuitry (not shown), and/or main memory. The L2 cache circuitry 1076 is coupled to one or more other levels of cache and eventually to a main memory.

The core 1090 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1090 includes logic to support a packed data instruction set architecture extension (e.g., AVX1, AVX2), thereby allowing the operations used by many multimedia applications to be performed using packed data.

### Exemplary Execution Unit(s) Circuitry

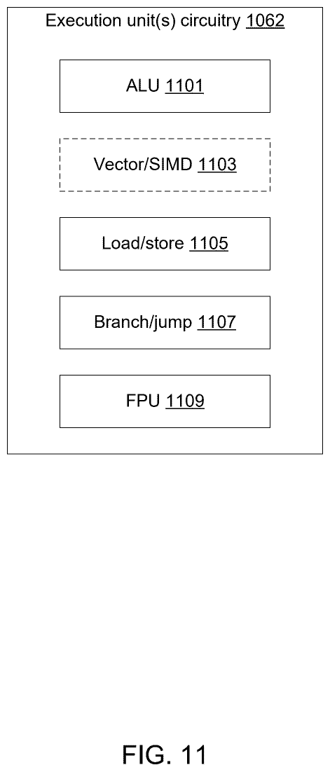

FIG. 11 illustrates examples of execution unit(s) circuitry, such as execution unit(s) circuitry 1062 of FIG. 10B. As illustrated, execution unit(s) circuity 1062 may include one or more ALU circuits 1101, optional vector/single instruction multiple data (SIMD) circuits 1103, load/store circuits 1105, branch/jump circuits 1107, and/or Floating-point unit (FPU) circuits 1109. ALU circuits 1101 perform integer arithmetic and/or Boolean operations. Vector/SIMD circuits 1103 perform vector/SIMD operations on packed data (such as SIMD/vector registers). Load/store circuits 1105 execute load and store instructions to load data from memory into registers or store from registers to memory. Load/store circuits 1105 may also generate addresses. Branch/jump circuits 1107 cause a branch or jump to a memory address depending on the instruction. FPU circuits 1109 perform floating-point arithmetic. The width of the execution unit(s) circuitry 1062 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

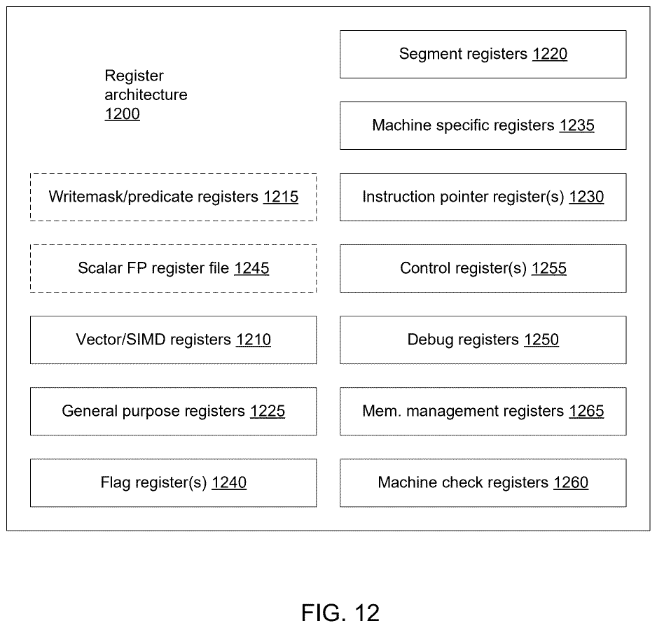

FIG. 12 is a block diagram of a register architecture 1200 according to some examples. As illustrated, the register architecture 1200 includes vector/SIMD registers 1210 that vary from 128-bit to 1,024 bits width. In some examples, the vector/SIMD registers 1210 are physically 512-bits and, depending upon the mapping, only some of the lower bits are used. For example, in some examples, the vector/SIMD registers 1210 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1200 includes writemask/predicate registers 1215. For example, in some examples, there are 8 writemask/predicate registers (sometimes called k0 through k7) that are each 16-bit, 32-bit, 64-bit, or 128-bit in size. Writemask/predicate registers 1215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1215 corresponds to a data element position of the destination. In other examples, the writemask/predicate registers 1215 are scalable and consists of a set number of enable bits for a given vector element (e.g., 8 enable bits per 64-bit vector element).

The register architecture 1200 includes a plurality of general-purpose registers 1225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1200 includes scalar floating-point (FP) register 1245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1240 (e.g., EFLAGS, RFLAGS, etc.) store status and control information for arithmetic, compare, and system operations. For example, the one or more flag registers 1240 may store condition code information such as carry, parity, auxiliary carry, zero, sign, and overflow. In some examples, the one or more flag registers 1240 are called program status and control registers.

Segment registers 1220 contain segment points for use in accessing memory. In some examples, these registers are referenced by the names CS, DS, SS, ES, FS, and GS.

Machine specific registers (MSRs) 1235 control and report on processor performance. Most MSRs 1235 handle system-related functions and are not accessible to an application program. Machine check registers 1260 consist of control, status, and error reporting MSRs that are used to detect and report on hardware errors.

One or more instruction pointer register(s) 1230 store an instruction pointer value. Control register(s) 1255 (e.g., CR0-CR4) determine the operating mode of a processor (e.g., processor 870, 880, 838, 815, and/or 900) and the characteristics of a currently executing task. Debug registers 1250 control and allow for the monitoring of a processor or core's debugging operations.

Memory (mem) management registers 1265 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1200 may, for example, be used in physical register file(s) circuitry 10 58.

Techniques and architectures for filtering prefetches at a processor are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In one or more first embodiments, an integrated circuit (IC) comprises first circuitry to identify a first address based on a demand memory access instruction, wherein a page of a cache comprises a line which corresponds to the first address, wherein, based on the first address, the first circuitry is further to perform an access of a record, wherein the record identifies X addresses which, of those addresses which each correspond to a respective line of the page, were most recently accessed each based on a respective demand memory access instruction, wherein X is a positive integer greater than one, second circuitry, coupled to the first circuitry, to perform an evaluation, based on the access, to detect for a condition wherein the first address is numerically adjacent to one of the X addresses, third circuitry, coupled to the second circuitry, to update a count variable based on the evaluation, wherein the count variable indicates a confidence in adjacent-line prefetches with the page, and fourth circuitry coupled to the third circuitry, wherein, based on the count variable, the fourth circuitry is to provide one of an enablement of adjacent-line prefetches with the page, or a disablement of adjacent-line prefetches with the page.

In one or more second embodiments, further to the first embodiment, where the evaluation indicates a presence of the condition, the third circuitry is to update the count variable to indicate an increase to the confidence.

In one or more third embodiments, further to the first embodiment or the second embodiment, where the evaluation indicates an absence of the condition, the third circuitry is to update the count variable to indicate a decrease to the confidence.

In one or more fourth embodiments, further to any of the first through third embodiments, the fourth circuitry to provide the enablement of adjacent-line prefetches with the page based on the count variable comprises the fourth circuitry to enable adjacent-line prefetches based on a determination that the confidence satisfies a minimum threshold criteria.

In one or more fifth embodiments, further to the fourth embodiment, the third circuitry is further to access a configuration register to determine the minimum threshold criteria.

In one or more sixth embodiments, further to the fourth embodiment, the fourth circuitry to provide the disablement of adjacent-line prefetches with the page based on the count variable comprises the fourth circuitry to disable adjacent-line prefetches based on a determination that the confidence fails to satisfy the minimum threshold criteria.

In one or more seventh embodiments, further to any of the first through third embodiments, the fourth circuitry to provide the enablement of adjacent-line prefetches with the page based on the count variable comprises the fourth circuitry to enable a prefetch of N lines of the cache, N is a positive integer greater than one, the N lines each correspond to a different respective one of N addresses, and each of the N addresses is numerically adjacent to a respective other one of the N addresses.

In one or more eighth embodiments, further to the seventh embodiment, the fourth circuitry is further to access a configuration register to determine the integer N.

In one or more ninth embodiments, further to any of the first through third embodiments, the cache is a first cache of a processor core, and the processor core further comprises a second cache which, relative to the first cache, is higher in a hierarchy of caches of the processor core.

In one or more tenth embodiments, further to any of the first through third embodiments, the IC further comprises fifth circuitry to maintain the record of X addresses.

In one or more eleventh embodiments, further to any of the first through third embodiments, the demand memory access instruction, the page, the cache, the line, the access, the record, the evaluation, the condition, the count variable, and the confidence are, respectively, a first demand memory access instruction, a first page, a first cache, a first line, a first access, a first record, a first evaluation, a first condition, a first count variable, and a first confidence, the first circuitry is further to identify a second address based on a second demand memory access instruction, wherein a second page of the cache comprises a second line which corresponds to the second address, based on the second address, the first circuitry is further to perform a second access of a second record which corresponds to the second page, wherein the second record identifies Y addresses which, of those addresses which each correspond to a respective line of the second page, were most recently accessed each based on a respective demand memory access instruction, wherein Y is a positive integer greater than one, the second circuitry is further to perform a second evaluation, based on the second access, to detect for a second condition wherein the second address is numerically adjacent to one of the Y most recently accessed addresses which each correspond to a respective line of the second page, the third circuitry is further to update a second count variable based on the second evaluation, wherein the second count variable indicates a second confidence in adjacent-line prefetches with the second page, and based on the second count variable, the fourth circuitry is further to provide one of an enablement of adjacent-line prefetches with the second page, or a disablement of adjacent-line prefetches with the second page.

In one or more twelfth embodiments, a method comprises identifying a first address based on a demand memory access instruction, wherein a page of a cache comprises a line which corresponds to the first address, based on the first address, performing an access of a record which corresponds to the page, wherein the record identifies X addresses which, of those addresses which each correspond to a respective line of the page, were most recently accessed each based on a respective demand memory access instruction, wherein X is a positive integer greater than one, performing an evaluation, based on the access, to detect for a condition wherein the first address is numerically adjacent to one of the X addresses, updating a count variable based on the evaluation, wherein the count variable indicates a confidence in adjacent-line prefetches with the page, and based on the count variable, performing one of enabling adjacent-line prefetches with the page, or disabling adjacent-line prefetches with the page.

In one or more thirteenth embodiments, further to the twelfth embodiment, the evaluation indicates a presence of the condition, and the count variable is updated, based on the evaluation, to indicate an increase to the confidence.

In one or more fourteenth embodiments, further to the twelfth embodiment or the thirteenth embodiment, the evaluation indicates an absence of the condition, and the count variable is updated, based on the evaluation, to indicate a decrease to the confidence.

In one or more fifteenth embodiments, further to any of the twelfth through fourteenth embodiments, enabling adjacent-line prefetches with the page based on the count variable comprises enabling adjacent-line prefetches based on a determination that the confidence satisfies a minimum threshold criteria.

In one or more sixteenth embodiments, further to the fifteenth embodiment, the method further comprises accessing a configuration register to determine the minimum threshold criteria.

In one or more seventeenth embodiments, further to the fifteenth embodiment, disabling adjacent-line prefetches with the page based on the count variable comprises disabling adjacent-line prefetches based on a determination that the confidence fails to satisfy the minimum threshold criteria.

In one or more eighteenth embodiments, further to any of the twelfth through fourteenth embodiments, enabling adjacent-line prefetches with the page based on the count variable comprises enabling a prefetch of N lines of the cache, N is a positive integer greater than one, the N lines each correspond to a different respective one of N addresses, and each of the N addresses is numerically adjacent to a respective other one of the N addresses.

In one or more nineteenth embodiments, further to the eighteenth embodiment, the method further comprises accessing a configuration register to determine the integer N.

In one or more twentieth embodiments, further to any of the twelfth through fourteenth embodiments, the cache is a first cache of a processor core, and the processor core further comprises a second cache which, relative to the first cache, is higher in a hierarchy of caches of the processor core.

In one or more twenty-first embodiments, further to any of the twelfth through fourteenth embodiments, the method further comprises maintaining the record of X addresses.

In one or more twenty-second embodiments, further to any of the twelfth through fourteenth embodiments, the demand memory access instruction, the page, the cache, the line, the access, the record, the evaluation, the condition, the count variable, and the confidence are, respectively, a first demand memory access instruction, a first page, a first cache, a first line, a first access, a first record, a first evaluation, a first condition, a first count variable, and a first confidence, and the method further comprises identifying a second address based on a second demand memory access instruction, wherein a second page of the cache comprises a second line which corresponds to the second address, based on the second address, performing a second access of a second record which corresponds to the second page, wherein the second record identifies Y addresses which, of those addresses which each correspond to a respective line of the second page, were most recently accessed each based on a respective demand memory access instruction, wherein Y is a positive integer greater than one, perform a second evaluation, based on the second access, to detect for a second condition wherein the second address is numerically adjacent to one of the Y most recently accessed addresses which each correspond to a respective line of the second page, updating a second count variable based on the second evaluation, wherein the second count variable indicates a second confidence in adjacent-line prefetches with the second page, and based on the second count variable, performing one of enabling adjacent-line prefetches with the second page, or disabling adjacent-line prefetches with the second page.

In one or more twenty-third embodiments, a system comprises a memory, a memory controller, and a processor coupled to the memory via the memory controller, the processor comprising first circuitry to identify a first address based on a demand memory access instruction, wherein a page of a cache comprises a line which corresponds to the first address, wherein, based on the first address, the first circuitry is further to perform an access of a record, wherein the record identifies X addresses which, of those addresses which each correspond to a respective line of the page, were most recently accessed each based on a respective demand memory access instruction, wherein X is a positive integer greater than one, second circuitry, coupled to the first circuitry, to perform an evaluation, based on the access, to detect for a condition wherein the first address is numerically adjacent to one of the X addresses, third circuitry, coupled to the second circuitry, to update a count variable based on the evaluation, wherein the count variable indicates a confidence in adjacent-line prefetches with the page, and fourth circuitry coupled to the third circuitry, wherein, based on the count variable, the fourth circuitry is to provide one of an enablement of adjacent-line prefetches with the page, or a disablement of adjacent-line prefetches with the page.

In one or more twenty-fourth embodiments, further to the twenty-third embodiment, where the evaluation indicates a presence of the condition, the third circuitry is to update the count variable to indicate an increase to the confidence.

In one or more twenty-fifth embodiments, further to the twenty-third embodiment or the twenty-fourth embodiment, where the evaluation indicates an absence of the condition, the third circuitry is to update the count variable to indicate a decrease to the confidence.

In one or more twenty-sixth embodiments, further to any of the twenty-third through twenty-fifth embodiments, the fourth circuitry to provide the enablement of adjacent-line prefetches with the page based on the count variable comprises the fourth circuitry to enable adjacent-line prefetches based on a determination that the confidence satisfies a minimum threshold criteria.

In one or more twenty-seventh embodiments, further to the twenty-sixth embodiment, the third circuitry is further to access a configuration register to determine the minimum threshold criteria.

In one or more twenty-eighth embodiments, further to the twenty-sixth embodiment, the fourth circuitry to provide the disablement of adjacent-line prefetches with the page based on the count variable comprises the fourth circuitry to disable adjacent-line prefetches based on a determination that the confidence fails to satisfy the minimum threshold criteria.

In one or more twenty-ninth embodiments, further to any of the twenty-third through twenty-fifth embodiments, the fourth circuitry to provide the enablement of adjacent-line prefetches with the page based on the count variable comprises the fourth circuitry to enable a prefetch of N lines of the cache, N is a positive integer greater than one, the N lines each correspond to a different respective one of N addresses, and each of the N addresses is numerically adjacent to a respective other one of the N addresses.

In one or more thirtieth embodiments, further to the twenty-ninth embodiment, the fourth circuitry is further to access a configuration register to determine the integer N.

In one or more thirty-first embodiments, further to any of the twenty-third through twenty-fifth embodiments, the cache is a first cache of a processor core, and the processor core further comprises a second cache which, relative to the first cache, is higher in a hierarchy of caches of the processor core.

In one or more thirty-second embodiments, further to any of the twenty-third through twenty-fifth embodiments, the processor further comprises fifth circuitry to maintain the record of X addresses.

In one or more thirty-third embodiments, further to any of the twenty-third through twenty-fifth embodiments, the demand memory access instruction, the page, the cache, the line, the access, the record, the evaluation, the condition, the count variable, and the confidence are, respectively, a first demand memory access instruction, a first page, a first cache, a first line, a first access, a first record, a first evaluation, a first condition, a first count variable, and a first confidence, the first circuitry is further to identify a second address based on a second demand memory access instruction, wherein a second page of the cache comprises a second line which corresponds to the second address, based on the second address, the first circuitry is further to perform a second access of a second record which corresponds to the second page, wherein the second record identifies Y addresses which, of those addresses which each correspond to a respective line of the second page, were most recently accessed each based on a respective demand memory access instruction, wherein Y is a positive integer greater than one, the second circuitry is further to perform a second evaluation, based on the second access, to detect for a second condition wherein the second address is numerically adjacent to one of the Y most recently accessed addresses which each correspond to a respective line of the second page, the third circuitry is further to update a second count variable based on the second evaluation, wherein the second count variable indicates a second confidence in adjacent-line prefetches with the second page, and based on the second count variable, the fourth circuitry is further to provide one of an enablement of adjacent-line prefetches with the second page, or a disablement of adjacent-line prefetches with the second page.

In one or more thirty-fourth embodiments, a processor comprises first circuitry to detect an access of a region of a cache of a processor, second circuitry coupled to the first circuitry, wherein based on the access, the second circuitry is to perform an evaluation of an access history record which corresponds to the region, and based on the evaluation, detect a violation of a criteria that a prefetch access of the region is to be followed by a corresponding demand memory access of the region, and third circuitry coupled to the second circuitry, wherein based on the violation of the criteria, the third circuitry is to enable a prefetch accessibility filter on the region.

In one or more thirty-fifth embodiments, further to the thirty-fourth embodiment, the access, and the evaluation are, respectively a first access, and a first evaluation, the first circuitry is further to detect a second access of the region, based on the second access, the second circuitry is further to perform a second evaluation of the access history record, and based on the second evaluation, detect a satisfaction of the criteria, and based on the satisfaction of the criteria, the third circuitry is further to disable the prefetch accessibility filter on the region.

In one or more thirty-sixth embodiments, further to the thirty-fourth embodiment or the thirty-fifth embodiment, the prefetch accessibility filter is specific to the region.

In one or more thirty-seventh embodiments, further to any of the thirty-fourth through thirty-sixth embodiments, the cache is shared by multiple cores of the processor.

In one or more thirty-eighth embodiments, further to the thirty-seventh embodiment, the cache is a last level cache of a cache hierarchy of the processor.

In one or more thirty-ninth embodiments, further to any of the thirty-fourth through thirty-sixth embodiments, the processor further comprises fourth circuitry to maintain the access history record which corresponds to the region, wherein the access history record comprises a first field to indicate whether a demand memory access of the region has been detected, a second field to indicate whether a prefetch access of the region has been detected, and a third field to indicate a relative order of the demand memory access and the prefetch access.

In one or more fortieth embodiments, further to any of the thirty-fourth through thirty-sixth embodiments, the access, the region, the evaluation, the access history record, the criteria, and the prefetch accessibility filter are, respectively, a first access, a first region, a first evaluation, a first access history record, a first criteria, and a first prefetch accessibility filter, the first circuitry is further to detect a second access of a second region of the cache, based on the access, the second circuitry is further to perform a second evaluation of a second access history record which corresponds to the second region, the second evaluation to detect for a violation of a second criteria that a prefetch access of the second region is to be followed by a corresponding demand memory access of the second region, and where the second evaluation indicates the violation of the second criteria, enable a second prefetch accessibility filter on the second region, and where the second evaluation indicates a satisfaction of the second criteria, the third circuitry is further to disable the second prefetch accessibility filter on the second region.

In one or more forty-first embodiments, a method at a processor comprises detecting an access of a region of a cache of the processor, based on the access, performing an evaluation of an access history record which corresponds to the region, based on the evaluation, detecting a violation of a criteria that a prefetch access of the region is to be followed by a corresponding demand memory access of the region, and based on the violation of the criteria, enabling a prefetch accessibility filter on the region.

In one or more forty-second embodiments, further to the forty-first embodiment, the access, and the evaluation are, respectively a first access, and a first evaluation, and the method further comprises detecting a second access of the region, based on the second access, performing a second evaluation of the access history record, based on the second evaluation, detecting a satisfaction of the criteria, and based on the satisfaction of the criteria, disabling the prefetch accessibility filter on the region.

In one or more forty-third embodiments, further to the forty-first embodiment or the forty-second embodiment, the prefetch accessibility filter is specific to the region.

In one or more forty-fourth embodiments, further to any of the forty-first through forty-third embodiments, the cache is shared by multiple cores of the processor.

In one or more forty-fifth embodiments, further to the forty-fourth embodiment, the cache is a last level cache of a cache hierarchy of the processor.

In one or more forty-sixth embodiments, further to any of the forty-first through forty-third embodiments, the method further comprises maintaining the access history record which corresponds to the region, wherein the access history record comprises a first field to indicate whether a demand memory access of the region has been detected, a second field to indicate whether a prefetch access of the region has been detected, and a third field to indicate a relative order of the demand memory access and the prefetch access.

In one or more forty-seventh embodiments, further to any of the forty-first through forty-third embodiments, the access, the region, the evaluation, the access history record, the criteria, and the prefetch accessibility filter are, respectively, a first access, a first region, a first evaluation, a first access history record, a first criteria, and a first prefetch accessibility filter, and the method further comprises detecting a second access of a second region of the cache, based on the access, performing a second evaluation of a second access history record which corresponds to the second region, the second evaluation to detect for a violation of a second criteria that a prefetch access of the second region is to be followed by a corresponding demand memory access of the second region, where the second evaluation indicates the violation of the second criteria, enabling a second prefetch accessibility filter on the second region, and where the second evaluation indicates a satisfaction of the second criteria, disabling the second prefetch accessibility filter on the second region.

In one or more forty-eighth embodiments, a system comprises a memory, a memory controller, and a processor coupled to the memory via the memory controller, the processor comprises first circuitry to detect an access of a region of a cache of a processor, second circuitry coupled to the first circuitry, wherein based on the access, the second circuitry is to perform an evaluation of an access history record which corresponds to the region, and based on the evaluation, detect a violation of a criteria that a prefetch access of the region is to be followed by a corresponding demand memory access of the region, and third circuitry coupled to the second circuitry, wherein based on the violation of the criteria, the third circuitry is to enable a prefetch accessibility filter on the region.

In one or more forty-ninth embodiments, further to the forty-eighth embodiment, the access, and the evaluation are, respectively a first access, and a first evaluation, the first circuitry is further to detect a second access of the region, based on the second access, the second circuitry is further to perform a second evaluation of the access history record, and based on the second evaluation, detect a satisfaction of the criteria, and based on the satisfaction of the criteria, the third circuitry is further to disable the prefetch accessibility filter on the region.

In one or more fiftieth embodiments, further to the forty-eighth embodiment or the forty-ninth embodiment, the prefetch accessibility filter is specific to the region.

In one or more fifty-first embodiments, further to any of the forty-eighth through fiftieth embodiments, the cache is shared by multiple cores of the processor.

In one or more fifty-second embodiments, further to the fifty-first embodiment, the cache is a last level cache of a cache hierarchy of the processor.

In one or more fifty-third embodiments, further to any of the forty-eighth through fiftieth embodiments, the system further comprises fourth circuitry to maintain the access history record which corresponds to the region, wherein the access history record comprises a first field to indicate whether a demand memory access of the region has been detected, a second field to indicate whether a prefetch access of the region has been detected, and a third field to indicate a relative order of the demand memory access and the prefetch access.

In one or more fifty-fourth embodiments, further to any of the forty-eighth through fiftieth embodiments, the access, the region, the evaluation, the access history record, the criteria, and the prefetch accessibility filter are, respectively, a first access, a first region, a first evaluation, a first access history record, a first criteria, and a first prefetch accessibility filter, the first circuitry is further to detect a second access of a second region of the cache, based on the access, the second circuitry is further to perform a second evaluation of a second access history record which corresponds to the second region, the second evaluation to detect for a violation of a second criteria that a prefetch access of the second region is to be followed by a corresponding demand memory access of the second region, and where the second evaluation indicates the violation of the second criteria, enable a second prefetch accessibility filter on the second region, and where the second evaluation indicates a satisfaction of the second criteria, the third circuitry is further to disable the second prefetch accessibility filter on the second region.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An integrated circuit (IC) comprising:
first circuitry to identify a first address based on a demand memory access instruction, wherein a page of a cache comprises a line which corresponds to the first address, wherein, based on the first address, the first circuitry is further to perform an access of a record, wherein the record identifies X addresses which, of those addresses which each correspond to a respective line of the page, were most recently accessed each based on a respective demand memory access instruction, wherein X is a positive integer greater than one;
second circuitry, coupled to the first circuitry, to perform an evaluation, based on the access, to detect for a condition wherein the first address is numerically adjacent to one of the X addresses;
third circuitry, coupled to the second circuitry, to update a count variable based on the evaluation, wherein the count variable indicates a confidence in adjacent-line prefetches with the page; and
fourth circuitry coupled to the third circuitry, wherein, based on the count variable, the fourth circuitry is to provide one of an enablement of adjacent-line prefetches with the page, or a disablement of adjacent-line prefetches with the page.

2. The IC of claim 1, wherein, where the evaluation indicates a presence of the condition, the third circuitry is to update the count variable to indicate an increase to the confidence.

3. The IC of claim 1, wherein, where the evaluation indicates an absence of the condition, the third circuitry is to update the count variable to indicate a decrease to the confidence.

4. The IC of claim 1, wherein the fourth circuitry to provide the enablement of adjacent-line prefetches with the page based on the count variable comprises the fourth circuitry to enable adjacent-line prefetches based on a determination that the confidence satisfies a minimum threshold criteria.

5. The IC of claim 4, wherein the fourth circuitry to provide the disablement of adjacent-line prefetches with the page based on the count variable comprises the fourth circuitry to disable adjacent-line prefetches based on a determination that the confidence fails to satisfy the minimum threshold criteria.

6. The IC of claim 1, wherein:
the fourth circuitry to provide the enablement of adjacent-line prefetches with the page based on the count variable comprises the fourth circuitry to enable a prefetch of N lines of the cache;
N is a positive integer greater than one;
the N lines each correspond to a different respective one of N addresses; and
each of the N addresses is numerically adjacent to a respective other one of the N addresses.

7. The IC of claim 1, wherein:
the cache is a first cache of a processor core; and
the processor core further comprises a second cache which, relative to the first cache, is higher in a hierarchy of caches of the processor core.

8. The IC of claim 1, further comprising fifth circuitry to maintain the record of X addresses.

9. A method comprising:
identifying a first address based on a demand memory access instruction, wherein a page of a cache comprises a line which corresponds to the first address;
based on the first address, performing an access of a record which corresponds to the page, wherein the record identifies X addresses which, of those addresses which each correspond to a respective line of the page, were most recently accessed each based on a respective demand memory access instruction, wherein X is a positive integer greater than one;
performing an evaluation, based on the access, to detect for a condition wherein the first address is numerically adjacent to one of the X addresses;
updating a count variable based on the evaluation, wherein the count variable indicates a confidence in adjacent-line prefetches with the page; and
based on the count variable, performing one of enabling adjacent-line prefetches with the page, or disabling adjacent-line prefetches with the page.

10. The method of claim 9, wherein:
the evaluation indicates a presence of the condition; and
the count variable is updated, based on the evaluation, to indicate an increase to the confidence.

11. The method of claim 9, wherein:
the evaluation indicates an absence of the condition; and
the count variable is updated, based on the evaluation, to indicate a decrease to the confidence.

12. The method of claim 9, wherein enabling adjacent-line prefetches with the page based on the count variable comprises enabling adjacent-line prefetches based on a determination that the confidence satisfies a minimum threshold criteria.

13. The method of claim 12, wherein disabling adjacent-line prefetches with the page based on the count variable comprises disabling adjacent-line prefetches based on a determination that the confidence fails to satisfy the minimum threshold criteria.

14. The method of claim 9, wherein:
enabling adjacent-line prefetches with the page based on the count variable comprises enabling a prefetch of N lines of the cache;
N is a positive integer greater than one;
the N lines each correspond to a different respective one of N addresses; and
each of the N addresses is numerically adjacent to a respective other one of the N addresses.

15. The method of claim 9, wherein:
the cache is a first cache of a processor core; and
the processor core further comprises a second cache which, relative to the first cache, is higher in a hierarchy of caches of the processor core.

16. A processor comprising:
first circuitry to detect an access of a region of a cache of a processor;
second circuitry coupled to the first circuitry, wherein based on the access, the second circuitry is to:
perform an evaluation of an access history record which corresponds to the region; and
based on the evaluation, detect a violation of a criteria that a prefetch access of the region is to be followed by a corresponding demand memory access of the region; and
third circuitry coupled to the second circuitry, wherein based on the violation of the criteria, the third circuitry is to enable a prefetch accessibility filter on the region.

17. The processor of claim 16, wherein:
the access, and the evaluation are, respectively a first access, and a first evaluation;
the first circuitry is further to detect a second access of the region;
based on the second access, the second circuitry is further to:
perform a second evaluation of the access history record; and
based on the second evaluation, detect a satisfaction of the criteria; and
based on the satisfaction of the criteria, the third circuitry is further to disable the prefetch accessibility filter on the region.

18. The processor of claim 16, wherein the prefetch accessibility filter is specific to the region.

19. The processor of claim 16, further comprising:
fourth circuitry to maintain the access history record which corresponds to the region, wherein the access history record comprises:
a first field to indicate whether a demand memory access of the region has been detected;
a second field to indicate whether a prefetch access of the region has been detected; and
a third field to indicate a relative order of the demand memory access and the prefetch access.

20. The processor of claim 16, wherein:
the access, the region, the evaluation, the access history record, the criteria, and the prefetch accessibility filter are, respectively, a first access, a first region, a first evaluation, a first access history record, a first criteria, and a first prefetch accessibility filter;
the first circuitry is further to detect a second access of a second region of the cache;
based on the access, the second circuitry is further to:
perform a second evaluation of a second access history record which corresponds to the second region, the second evaluation to detect for a violation of a second criteria that a prefetch access of the second region is to be followed by a corresponding demand memory access of the second region; and
where the second evaluation indicates the violation of the second criteria, enable a second prefetch accessibility filter on the second region; and
where the second evaluation indicates a satisfaction of the second criteria, the third circuitry is further to disable the second prefetch accessibility filter on the second region.
